(19) United States
(12) Patent Application Publication
(10) Pub. No.: US 2011/0055868 A1
(43) Pub. Date: Mar. 3, 2011

(54) METHOD AND DEVICE FOR RECEIVING A DIGITAL TELEVISION CONVEYANCE STREAM, AND CORRESPONDING DIGITAL TELEVISION RECEIVER AND COMPUTER SOFTWARE

(75) Inventors: Joseph Antunes, Massy (FR); Guillaume Defoug, Paris (FR)

(73) Assignee: DIBCOM, Palaiseau (FR)

(21) Appl. No.: 12/809,305

(22) PCT Filed: Dec. 18, 2008
(86) PCT No.: PCT/FR2008/052367

§ 371 Date: Oct. 21, 2010

(30) Foreign Application Priority Data
Dec. 21, 2007 (FR) 0760298

(51) Int. Cl. H04N 5/445

(52) U.S. Cl. 725/40

(57) ABSTRACT

The reception method including:
a step of recovering (18) a transport packet TS, the transport packet TS conveying a SI/PSI table, and the SI/PSI table including a version field; and
a step of reading (20) the value of the version field of the SI/PSI table conveyed by the transport packet TS,
is characterized in that it includes:
a step of comparison (22) of the read value of the version field of the SI/PSI table with a recorded value; and
in the case where the read value is different from the recorded value:
a step of recovery (30) of the whole of the SI/PSI table; and
a step of recording (32) the read value in place of the recorded value.

The present invention relates to a method of reception, by a handheld DVB-H digital television receiver, of a DVB digital television transport stream comprising transport packets TS, said reception method comprising:

a step of recovering a transport packet TS, the transport packet TS conveying a SI/PSI table, the SI/PSI table comprising a version field; and

a step of reading the value of the version field of the SI/PSI table conveyed by the transport packet TS.

It also concerns a corresponding reception device, DVB-H receiver and computer program.

More particularly, the invention relates to DVB (Digital Video Broadcasting) systems, in particular the broadcasting systems for handheld DVB-H receivers (Digital Video Broadcast for Handheld terminals).

The DVB-H system was introduced in order to be able to broadcast transport streams of the DVB type to a handheld receiver having limited resources in terms of battery.

The data of the DVB transport streams are of two types.

They are thus either useful data which define services or service information called SI/PSI information (Service Information/Program Specific Information) which describe the means in particular in terms of network for accessing the useful data.

The SI service information is defined in the form of tables which define, among other things, a network identifier determining solely the network used for routing the useful data of at least one service by a platform identifier which determines solely the platform supporting the routing of the useful data of the, or of one of these, service(s) and by a program identifier of the transport stream packets TS (Transport Stream) which route the useful data of the or these service(s).

The program specific information (PSI) is also defined in the form of tables making it possible, among other things, to gain access to the elementary streams constituting a service, for example to each audio and video stream of an audiovisual program service selected by a user and to synchronise the elementary streams during their decoding and their presentation to the user.

In the continuation of the description, the SI/PSI information will be called service information.

The SI/PSI service information allows the DVB-H receiver to obtain the indications of designation of a service. The SI/PSI service information comprises a certain number of different SI/PSI tables. The SI/PSI tables are used in particular for decoding the digital television services.

In addition, it should be noted that the SI/PSI tables are broadcast regularly with a recurrence sufficient to update the information at the DVB-H receiver.

Conventionally, the recovery of the whole of the SI/PSI tables conveyed on the DVB transport stream is carried out regularly, according to a fixed period. This recovery operation requires the DVB-H receiver to be kept switched on for a duration of ten seconds.

It can be imagined that this has its drawbacks. Since the updating of the SI/PSI tables in the receiver takes place only according to a fixed period, the changes which have taken place in the service information in the interval where there has been no updating are not taken into account. Conversely, in the case where there has not been any change in the interval, switching the receiver on for ten seconds proves useless. In this case there is useless consumption of the battery power.

The aim of the invention is to solve this problem.

More particularly, the invention aims to avoid unnecessary consumption of the battery of the DVB-H receiver for the recovery of the SI/PSI service information tables.

To this end, the subject of the invention is a method of reception, by a handheld DVB-H digital television receiver, of a DVB digital television transport stream comprising transport packets TS, said reception method comprising:

a step of recovering a transport packet TS, the transport packet TS conveying a SI/PSI table, and the SI/PSI table comprising a version field; and

a step of reading the value of the version field of the SI/PSI table conveyed by the transport packet TS;

characterized in that it comprises:

a step of comparison of the read value of the version field of said SI/PSI table with a recorded value; and

in the case where the read value is different from the recorded value:

a step of recovery of the whole of the SI/PSI table,

a step of recording the read value in place of the recorded value; and

a step of recovering, in a predetermined period of time, following succeeding SI/PSI service information tables.

According to particular embodiments, the method comprises one or more of the following features, taken individually or in any technically possible combination:

the SI/PSI table is not recovered in the case where the read value is identical to the recorded value,

the method comprises a step of recovery of all the following succeeding SI/PSI service information tables.

The invention also has as a subject a reception device for receiving a DVB digital television transport stream comprising transport packets TS, said reception device comprising:

recovery means for recovering a transport packet TS, the transport packet TS conveying a SI/PSI table, and the SI/PSI table comprising a version field; and

reading means for reading the value of the version field of the SI/PSI table conveyed by the transport packet TS;

characterized in that it comprises:

means for comparison of the read value of the version field of said SI/PSI table with a recorded value;

means for recovery in the case where the read value is different from the recorded value, of the whole of the SI/PSI table;

means for recording, in the case where the read value is different from the recorded value, the read value in place of the recorded value; and

means for recovering, in a predetermined period of time, in the case where the read value is different from the recorded value, following succeeding SI/PSI service information tables.

The invention also has as its subject a DVB-H handheld digital television receiver, characterized in that it comprises a reception device such as described above.

The invention also has as its subject a computer program comprising code instructions which, when the program is carried out on a computer, implement a method of reception of a digital television transport stream such as described above.

A description will now be given of the embodiments of the invention in a more precise but non-limiting manner with reference to the appended drawings, in which:

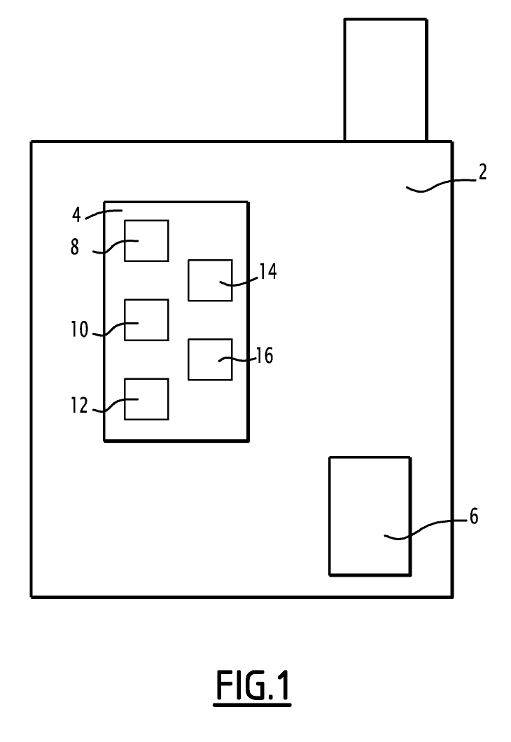

FIG. 1 shows a handheld terminal comprising a device for receiving a DVB transport stream according to the invention; and

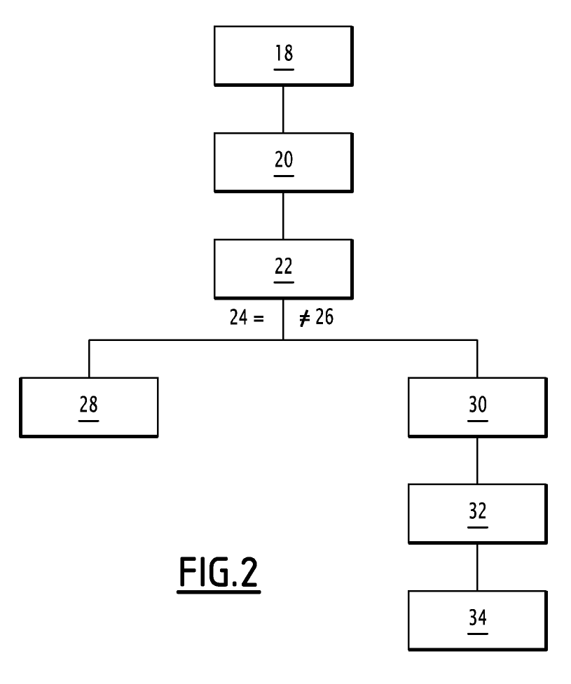

FIG. 2 is a flow chart illustrating a method of reception of a DVB transport stream according to the invention, implemented by the device of FIG. 1.

FIG. 1 shows a handheld terminal 2 equipped with a DVB-H receiver 4 and with means 6 for interaction between the terminal 2 and the receiver 4.

The DVB-H receiver 4 is equipped with recovery means 8 for recovering transport packets TS, and reading means 10 for reading the version field values contained in SI/PSI service information tables contained in said transport packets.

The DVB-H receiver 4 is also equipped with means for recording and storing 12 the version field values of the SI/PSI service information tables.

Moreover, the receiver 4 is equipped with comparison means 14 for comparing a version field value read by the reading means 10 with a version field value recorded in the recording and storing means 12.

In addition, the DVB-H receiver 4 comprises recovery means 16 for recovering the SI/PSI service information tables.

The structure of the DVB-H receiver 4 having been described, the remainder of the description relates to the functioning of a method of reception of a DVB transport stream according to the invention, implemented by the device of FIG. 1.

The transport packets TS transport the service data by time division multiplexing. Thus, the transport packets TS of a service are emitted with a certain frequency, for example, every three seconds. Between two transport packets TS of this service, the transport packets TS of the other services are sent.

Thus, in the DVB-H system, when the terminal 2 receives only one service, it is possible only to switch on the receiver periodically, with the preceding frequency (for example every three seconds), which permits the electrical shut-off of certain parts of the handheld terminal. The service life of the battery is therefore extended.

Moreover, SI/PSI tables are inserted at regular intervals in the transport packets TS (independently of the service which they convey). At each interval, one of the SI/PSI tables is inserted. The frequency with which a SI/PSI table is inserted is different for each SI/PSI table. Thus, one SI/PSI table may be inserted several times into the transport stream, while another SI/PSI table is inserted only once into the transport stream.

Even when receiving only one service, it frequently occurs that a large part of the transport packets TS conveying the service comprise a SI/PSI table. It is this property that is exploited hereinafter.

Thus, the recovery means 8 recover at 18 an n^{th} transport packet TS which conveys a SI/PSI table.

The SI/PSI table comprises a version field, the value of which changes when the data of the SI/PSI table change.

At 20, the reading means 10 read the value of the version field of the SI/PSI table conveyed in the n^{th} transport packet TS.

At 22, the comparison means 14 compare the read value with a recorded value of said field, stored in the recording and storing means 12.

In the case where the result of the comparison indicates at 24 that the read value of the version field of the SI/PSI table is the same as the recorded value of said version field, the associated SI/PSI table is not recovered at 28. The result of the comparison indicates that the current version of said table is identical to the previous version of the table known by the DVB-H receiver 4 at the outcome of a previous recovery. It is therefore useless to recover this table a second time.

However, if the result of the comparison indicates at 26 that the read value is different from the recorded value, the recovery means 16 for recovering the SI/PSI tables recover at 30 the whole of the SI/PSI table conveyed in the n^{th} transport packet TS, so that this SI/PSI table is used by the terminal 2.

Following this recovery, the recording and storing means 12 record the read value at 32 in place of the recorded value.

According to another embodiment of the invention, the recovery means 16 for recovering the SI/PSI tables recover at 30 not only the SI/PSI table concerned but also a certain number of following succeeding SI/PSI tables. In order to do this, the DVB-H receiver is kept switched on for a predetermined period of time. This predetermined period of time is selected so that the number of succeeding SI/PSI tables received is sufficient for each different SI/PSI table to be received at least once. Thus, all the SI/PSI tables are received and recorded, so that they are used by the terminal 2.

According to this embodiment, at 32 the recording and storing means 12 replace the recorded values of the version fields of all the SI/PSI tables with their values read at 10.

At 34, the SI/PSI service information tables recovered at 30 are transmitted by means of interaction 6 between the terminal 2 and the receiver 4 so that a user of the terminal 2 can gain access to the desired DVB-H services.

Steps 18 to 24 are then repeated for the (n+1)^{th} transport packet TS and so on, in order to recover only the SI/PSI tables in which the version field has changed.

Thus, the invention makes it possible only to carry out the recovery of a SI/PSI table when a version change in the table is detected. This makes it possible not to consume the power of the terminal battery uselessly as in the prior art.

In addition, since the version fields in the SI/PSI tables are searched on each recovery of a transport packet TS, the invention makes it possible to improve the time taken to take account of a change of a SI/PSI table compared with the prior art.

1. A method of reception, by a DVB-H handheld digital television receiver (4), of a DVB digital television transport stream comprising transport packets TS, said reception method comprising:
a step of recovering (18) a transport packet TS, the transport packet TS conveying a SI/PSI table, and the SI/PSI table comprising a version field; and
a step of reading (20) the value of the version field of the SI/PSI table conveyed by the transport packet TS,
characterized in that it comprises:
a step of comparison (22) of the read value of the version field of said SI/PSI table with a recorded value; and
in the case where the read value is different from the recorded value:
a step of recovery (30) of the whole of the SI/PSI table,
a step of recording (32) the read value in place of the recorded value; and
a step of recovering, in a predetermined period of time, following succeeding SI/PSI service information tables.

2. A reception method according to claim 1, characterized in that the SI/PSI table is not recovered in the case where the read value is identical to the recorded value.

3. A reception method according to claim 1, characterized in that the method comprises a step of recovery of all the following succeeding SI/PSI service information tables.

4. A device for receiving a DVB digital television transport stream comprising transport packets TS, said reception device comprising:
means for recovering (8) a transport packet TS, the transport packet TS conveying a SI/PSI table, and the SI/PSI table comprising a version field; and
reading means for reading (10) the value of the version field of the SI/PSI table conveyed by the transport packet TS;
characterized in that it comprises:
means for comparison (14) of the read value of the version field of said SI/PSI table with a recorded value;
means for recovery (16), in the case where the read value is different from the recorded value, of the whole of the SI/PSI table;
means for recording (12), in the case where the read value is different from the recorded value, the read value in place of the recorded value; and
means for recovering, in a predetermined period of time, in the case where the read value is different from the recorded value, following succeeding SI/PSI service information tables.

5. A handheld DVB-H digital television receiver (4), characterized in that it comprises a reception device according to claim 4.

6. A computer program comprising code instructions which, when the program is carried out on a computer, implement a method of reception of a digital television transport stream according to claim 1.
